(19) United States
(12) Patent Application Publication
(10) Pub. No.: US 2001/0052942 A1
(43) Pub. Date: Dec. 20, 2001

(54) Electronic camera system with modular printer and base

(76) Inventors: George O. MacCollum, Bellingham, MA (US); Scott D. Wicker, Andover, MA (US); Trung Q. Phung, Providence, RI (US); James J. Leftwich, Palo Alto, CA (US)

Correspondence Address: Orlando Lopez, POLAROID CORPORATION, Patent Department, 784 Memorial Drive, Cambridge, MA, 02139, US

(21) Appl. No.: 09/756,394

(22) Filed: Jan. 8, 2001

Related U.S. Application Data
(60) Provisional application No. 60/179,131, filed on Jan. 31, 2000.

(51) Int. Cl. H04N 5/222

(52) U.S. Cl. 348/333.01

(57) ABSTRACT

A compact, handheld portable electronic imaging system including both an electronic imaging camera and hard copy printer are separately housed with respect to each other and readily interfaceable with respect to each other for use either in combination or apart. In addition, a base unit provides a connection to a personal computer or network and provides power to recharge the batteries in the electronic imaging camera. Wireless transceiver interface means for transmitting electronic images between the electronic imaging camera and printer are provided so that when used apart, image defining electronic image information signals may be directed to the printer for the making of hard copies therefrom. A display viewfinder allows the user to see the scene in bright sun light and provides visual feedback and operation with a single user control which results in a simplified user interface. Alternatively, the electronic imaging camera and printer may be used in mechanical combination to provide an immediate hard copy of the image sensed in a manner analogous to that of an instant photographic camera of the self-processing type.

### RELATED APPLICATIONS

This application claims the benefit of co-pending U.S. Provisional Application No. 60/179,131 entitled “Electonic Camera System With Modular Printer And Base” filed on Jan. 31, 2000 (Attorney Docket No. C8418 PRO).

This application is related to commonly owned U.S. patent application Ser. No. 08/703,985 entitled “Optical System for Use in a Photographic Printer,” now U.S. Pat. No. 5,864,390; U.S. patent application Ser. No. 08/931,732 entitled “Apparatus for Reducing Linear Artifacts in Optically Printed-Image,” now U.S. Pat. No. 5,982,529; U.S. patent application Ser. No. 08/931,571 entitled “Optical System for Transmitting A Graphical Image, now U.S. patent 6,014,202; U.S. patent application Ser. No. 08/931,252 entitled “Light-Emitting Diode Having Uniform Irradiance Distribution,” now U.S. Pat. No. 5,990,498; co-pending U.S. patent application 08/929,972 entitled “Optical System for Use in a Photographic Printer;” U.S. patent application Ser. No. 08/931,570 entitled “Print Head Drive Assembly”; U.S. patent application Ser. No. 08/931,351 entitled “Retractable Print Medium Tray for Use in an Optical Printer”; and U.S. patent application Ser. No. 09/409,795 (being a Divisional of Ser. No. 08/931,571) entitled “Optical System for Transmitting a Graphical Image,” of which all of above listed applications and patents are incorporated herein by reference.

This application is also related to commonly owned co-pending U.S. patent application Ser. No. 09/495,025 entitled “Processing Fluid Spread System for an Electronic Photographic Printer and Camera and Related Method Thereof” (Attorney Ref. No. C8400); Ser. No. 09/495,029 entitled “Film Unit Drive Assembly for an Electronic Photographic Printer and Camera and Related Method Thereto” (Attorney Ref. No. C8401); U.S. patent application Ser. No. 09/495,026 entitled “Processing Fluid Spread System for a Detachable Electronic Photographic Printer and Camera and Related Method Thereto” (Attorney Ref. No. C8402); U.S. patent application Ser. No. 09/495,023 entitled “Film Unit Drive Assembly for a Detachable Electronic Photographic Printer and Camera and Related Method Thereto” (Attorney Ref. No. C8403); and U.S. provisional application Ser. No. 60/179,224 entitled “Cylindrical Minor Aperture Stop” (Attorney Ref. No. C8404); each application listed above are concurrently filed with the present application and are incorporated herein by reference.

### BACKGROUND OF THE INVENTION

1. Field Of the Invention

This invention relates generally to a modular electronic imaging system, and more particularly, to an electronic imaging system comprising both a camera and printer separately housed and wirelessly interfaceable with respect to each other and also readily connectable to a base unit which is connectable to a personal computer or a network.

2. Description of the Prior Art

Handheld electronic imaging cameras that can electronically record an image of a scene and thereafter print out on a separately housed printer a hard copy print of the recorded image on a photosensitive image receiving sheet such as that disclosed in U.S. Pat. No. 4,937,676, entitled “Electronic Camera System with Detachable Printer, ” by Finelli et al., issued Jun. 26, 1990 in common assignment herewith, are now known to the art. The electronic camera and printer disclosed by Finelli et al. are built as modular units but must be physically and electrically connected or utilize a transferable memory storage device when hard copy prints are desired. In addition, a cable or the memory storage device in the form of a memory card or magnetic media is required for storage or transfer of images from the camera to an image storage system or to a network. Also known in the art are electronic imaging modules which are insertable into a conventional photographic camera and can store the images or transmit the images over a wireless link to a base station. The base station can have a printer connected as a peripheral such as that disclosed in U.S. Pat. No. 5,561,458, entitled “Electronic Imaging Module for Reversibly Converting a Photographic Camera into an Electronic Imaging Camera,” by Cronin et al., issued Oct. 1, 1996. The printer disclosed by Cronin et al. is not portable and does not directly communicate with the camera.

Print engines using integral self-developing film units are described in the patents and applications cross-referenced above and are incorporated by reference. These references disclose a digital printer using instant film with or without an integral battery. The use of an electronic camera, a printer, and a personal computer is complicated by need for several cables, numerous buttons, controls and status indicators, and the use of several software packages to produce high quality images with the correct resolution and format.

Thus a problem not solved by the prior art is the need for numerous controls, indicator lights, and select switches on the electronic imaging camera, and these controls can often complicate the operation of the camera and confuse the operator. The complicated operation of printing the images including connecting the cables, selecting format and resolution, sending image data from the camera to a computer, using software applications to perform picture quality enhancements, and finally sending the processed image to a printer in order to obtain a hard copy print of the digital image stored in the camera is a further disadvantage of prior art systems. If more than one type of camera is used, then the image processing operations and the printer setting selections must be repeated.

Another problem with prior art solutions having an interface using electrical contacts or a separate memory storage device between the printer and the camera is insuring a reliable positive electrical connection each time the camera and printer are connected with each other or the memory device. Over time the contacts can become dirty or worn causing an intermittent connection and erratic operation

### SUMMARY OF THE INVENTION

A readily portable electronic imaging system comprises a electronic imaging camera housing of a size that may be conveniently carried by hand and a printer housing distinct from the electronic imaging camera housing that is also of a size that may be separately and conveniently carried by hand or attached mechanically to the electronic imaging camera. An objective lens is operatively disposed with respect to the electronic imaging camera housing to receive and focus incident light defining scene light. A solid state light responsive array is disposed within the electronic imaging camera housing for receiving incident scene light by way of the objective lens and converting the scene light into an image defining electronic information signal. Memory inside the electronic imaging camera housing provides storage for multiple images. A hard copy printing engine is disposed within the printer housing for making a hard copy of select images from the image defining electronic information signals.

Signal control and processing means have portions thereof disposed respectively within the electronic imaging camera and printer housings. The signal control and processing means responds to user selection to effect an exposure interval and thereafter process the image defining electronic information signals to effect a select transformation thereof. The signal control means thereafter responds to user selection to direct the transformed electronic information signals to either the electronic imaging camera memory for storage therein or to the hard copy printer for printing the image.

Both the electronic imaging camera and hardcopy printer include a wireless transceiver interface module which allows images and control information to be communicated between the electronic imaging camera and hard copy printer without an electrical or a mechanical connection. The system also includes a base unit that provides a docking station for recharging the electronic imaging camera battery and transferring data to and from the electronic imaging camera. The base unit can be connected to a personal computer, a switched network through a modem, or a network such as the Internet or an intranet. The portion of the signal control and processing means disposed within the printer housing is responsive to user selection from the electronic imaging camera when the printer housing is either disconnected from the electronic imaging camera housing or when connected to the electronic imaging camera housing.

The use of a wireless transceiver interface has several advantages over the traditional approach of requiring an electrical connection between the camera and printer. The small hand held camera can capture an image and transmit the images to a mobile print engine in the field which can service several capture devices. When the operator returns home the electronic imaging camera can then communicate to a variety of devices within the range of wireless transceiver interface including waking up a wireless enabled base station or personal computer to transfer images without any keyboard commands or further actions from the user. The images can also be transferred by docking the camera in the base unit. Complementary releasable connecting means operatively associated with respect to the electronic imaging camera and printer housings are provided for effecting a releasable fixed connection between the electronic imaging camera and printer housings.

Therefore, it is a primary object of this invention to provide a compact, handheld electronic imaging system comprising a electronic imaging camera, a printer and a base unit separately housed and interfaceable for selective use either together or apart. It is a further object of this invention to provide wireless printing from a handheld electronic imaging camera or from a base unit which may be connected to a personal computer or the internet.

It is a further object of this invention to provide a compact, handheld electronic imaging system comprising an electronic imaging camera, printer and base unit usable either apart or in connection with respect to each other wherein the interface among the components is wireless requiring no cables to transfer image data or control information. It is a further object of this invention to provide image processing software applications that contain information on the device characteristics of the electronic imaging camera and can be executed in the electronic imaging camera and the printer. The characteristic information and software applications can automatically be uploaded from the personal computer or the network and stored into the electronic imaging camera, which can automatically identify itself, and load data and software components into the printer in order to produce optimum picture quality both for printing and image storage.

It is a further object of this invention to allow the electronic imaging camera and printer components to be connected and easily carried in one hand. It is a further object of this invention to provide simplified operation of the electronic imaging camera by use of an display viewfinder allowing the user to see the scene in bright sun light providing visual feedback and a multifunction switch and an action button. It is a further object of this invention to provide ease of use features to enable a user to transmit images to preselected computers via the internet without complicated steps.

Other objects of the invention will be, in part, obvious and will, in part, appear hereinafter. The invention accordingly comprises a mechanism and system possessing the construction, combination of elements and arrangement of parts which are exemplified in the following detailed disclosure.

### DESCRIPTION OF THE DRAWINGS

The novel features that are considered characteristic of the invention are set forth with particularity in the appended claims. The invention itself, however, both as to its organization and its method of operation, together with other objects and advantages thereof will be best understood from the following description of the illustrated embodiment when read in connection with the accompanying drawings wherein:

FIG. 1 is a diagram of the components of the electronic imaging system according to this invention;

FIG. 2A is a view of the front of the electronic imaging camera of the electronic imaging system of FIG. 1;

FIG. 2B is a view of the back of the electronic imaging camera of the electronic imaging system of FIG. 1;

FIG. 3 is a perspective view of the hard copy printer of the electronic imaging system of FIG. 1;

FIG. 4 is a block diagram of the interfaces of the electronic imaging system of FIG. 1;

FIG. 5 is a circuit block diagram of the electronic imaging system of FIG. 1;

FIG. 6 is a view of the ergonomic user interface of the electronic imaging camera according to this invention;

FIG. 7 is a view of a right handed electronic imaging camera transformed into a left handed electronic imaging camera according to this invention;

FIG. 8 is a view of the operation of the ergonomic user interface of the electronic imaging camera according to this invention;

FIG. 9A is a view of the display viewfinder of the electronic imaging camera in a vertical configuration according to this invention;

FIG. 9B is a view of the display viewfinder of the electronic imaging camera in a horizontal configuration according to this invention;

FIG. 10 is a perspective view of the electronic imaging camera, hard copy printer, and base unit of the electronic imaging system of FIG. 1; and

Appendix A pages a1, a2, a3, a5 show details of the ergonomic features and user interface according to this invention.

### DESCRIPTION OF THE PREFERRED EMBODIMENTS

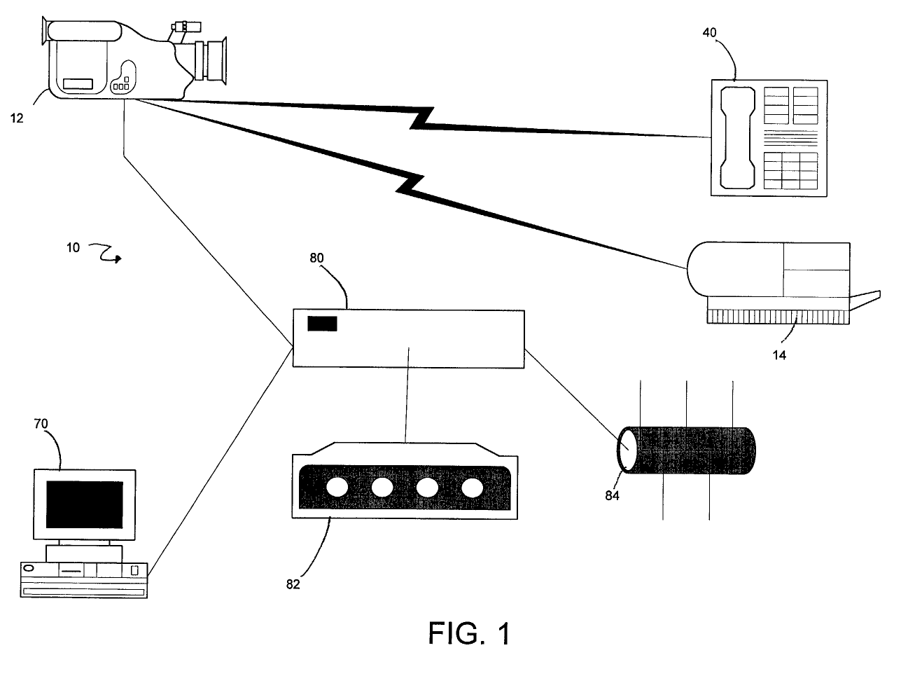

Referring to FIG. 1, there is shown at 10 the electronic imaging system of this invention comprising an electronic imaging camera 12, a hard copy printer 14 and a base unit 80. The base unit 80 is used to dock either the electronic imaging camera 12 or the electronic imaging camera 12 combined with the hard copy printer 14. The base unit 80 also supplies power to the electronic imaging camera 12 when docked and facilitates a data connection between the electronic imaging camera 12 and other connected devices or networks. The base unit 80 can be connected to a personal computer 70, a switched network through a modem 82, which can be internal or external to the base unit 80, or a network 84. The electronic imaging camera 12 can also transfer images and receive information from a cellular telephone 40 which is equipped with a wireless transceiver interface and a cellular data modem. Image data and status and control information is communicated wirelessly between the electronic imaging camera 12 and hard copy printer 14. Multiple electronic imaging cameras 12 can communicate with one or more hard copy printers 14, and electronic imaging cameras 12 can communicate with other electronic imaging cameras to provide special effects or synchronized multiple exposures by actuating the shutters of several cameras by wireless control. Each device, such as the electronic imaging camera 12 and hard copy printer 14 has a unique identification number in a preferred embodiment.

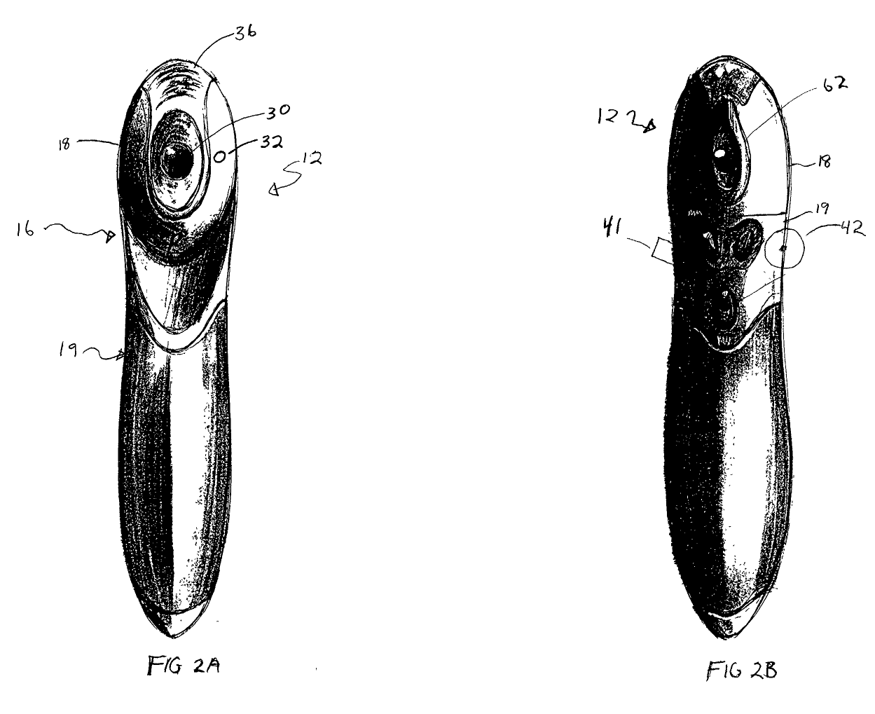

As best viewed in FIG. 2A, the electronic imaging camera 12 comprises an ergonomically shaped electronic imaging camera housing 16 defined by a upper portion 18 and a lower portion 19. The front of the upper portion 18 of the electronic imaging camera housing 16 contains an opening for admitting scene light to an objective lens 30 disposed therein. The upper portion 18 also contains an electronic strobe discharge window 36 through which artificial light is provided to illuminate a scene in a well-known manner. In an alternate embodiment, the objective lens 30 may include a manually actuable telephoto feature as is well known in the art actuable by way of a user select button 32 disposed on the upper portion 18. The strobe discharge window 36 is slidably mounted on the upper portion 18 of the camera 12 housing and serves as a lens cover when the electronic imaging camera 12 is not in operation. When the electronic imaging camera 12 is in operation the strobe discharge window 36, and lens cover (not shown) are extended upwards uncovering the lens. Use of the electronic strobe built into the electronic imaging camera 12 may be commenced at the discretion of the user through a user interface described more fully below. Complete charging of the electronic strobe is signified through the user interface. The electronic imaging camera housing 16 is of a size that can be easily held by hand and is readily portable for field use. The electronic imaging camera housing can incorporate soft goods, such as a neoprene soft touch handle, in order to provide a more comfortable grip for the user and a soft goods case may also be used to attach the electronic imaging camera 12 to the hard copy printer 14. FIG. 2B shows the back of the electronic imaging camera 12 which includes display viewfinder 62 using a miniature liquid crystal display (LCD) in a preferred embodiment. The display viewfinder 62 is used as a viewfinder for taking pictures, a display for reviewing stored images, and as a display for the user interface which can display status information and control and setup menus. The lower portion 19 has an action button 41 and a thumb-operable clickable roller multifunction switch 42.

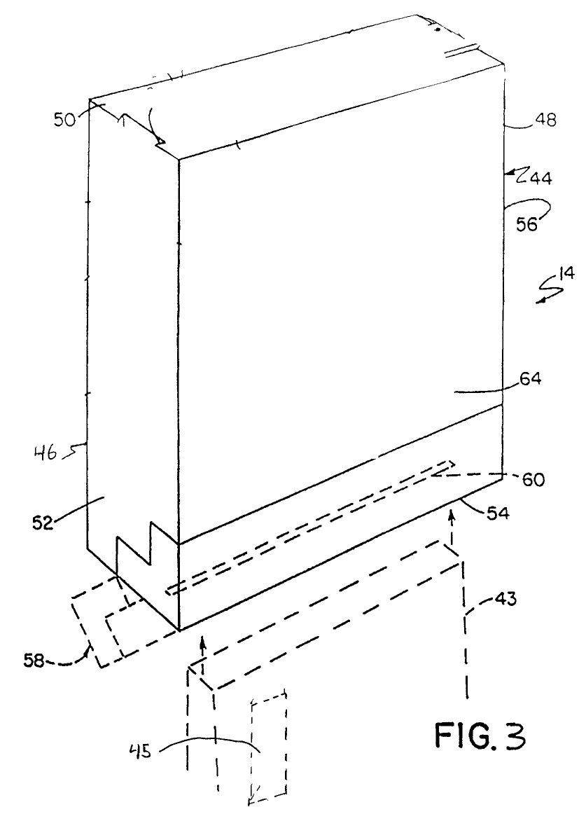

Now referring to FIG. 3, the printer housing 44 comprises a substantially planar major bottom wall member 46 spaced apart in parallel relation to a substantially planar major top wall member 48. The wall members 46, 48 are described as bottom and top wall members. The wall members 46, 48 are interconnected by substantially planar minor side wall members 50, 52, 54, 56 to form a parallelepiped structure as shown. The side wall member 54 forms the major portion of a pivotal door assembly as shown in phantom at 58 in its open position to accommodate the insertion of a film cassette 43 comprising a stack of integral self-developing film units and a battery 45 of a type manufactured by the Polaroid Corporation and well known in the art. Side wall member 54 in the pivotal door assembly 58 includes a film exit slot 60 to accommodate the exit of individual ones of the integral self-developing film units as they are exposed by the hard copy printer 14 in a manner as more fully described in the previously cross referenced patents and co-pending applications. The printer housing 44 is also of a size that can be easily held by hand and is also readily portable for field use even when connected to the electronic imaging camera housing 16 in the manner of this invention. Complementary releasable connecting means operatively associated with respect to the electronic imaging camera housing 16 and printer housing 44 are respectively provided for effecting a releasable fixed connection between the electronic imaging camera and the printer housings so that both the electronic imaging camera 12 and the hard copy printer 14 can be operated together in the manner of this invention. The releasable connecting means preferably comprises a mechanical latch with snap-together fittings.

Alternatively, the electronic imaging camera housing 16 and the printer housing 44 can be mechanically attached to each other by velcro attachment, a magnetic attachment or by placing the electronic imaging camera 12 and hard copy 14 printer in a soft goods case.

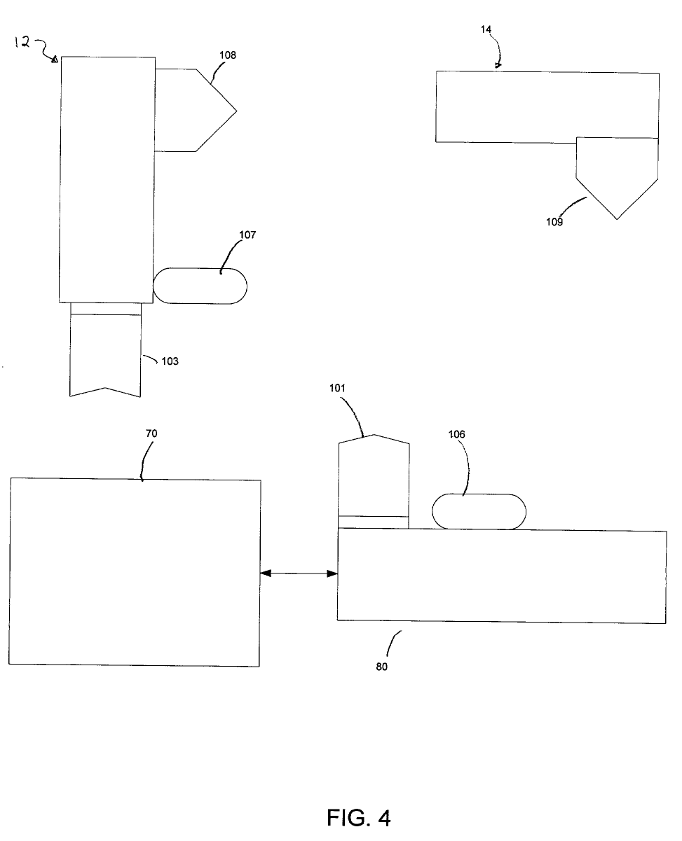

Referring now to FIG. 4, in a preferred embodiment the connection between the electronic imaging camera 12, the base unit 80 is via a universal serial bus (USB) connection 106, 107. The personal computer 70 can be connected to the base unit 80 via a USB connection (not shown) in a preferred embodiment to facilitate the transfer of images and control information to the electronic imaging camera 12. In an alternate embodiment, the connection to the computer 70 could be a parallel interface, SCSI interface, serial connection or a FireWire connection, a cross-platform implementation of the high-speed serial data bus defined by IEEE Standard 1394-1995. The electronic imaging camera 12 can communicate with the hard copy printer 14 through a wireless transceiver interface 108 on electronic imaging camera 12, and wireless transceiver interface 109 on hard copy printer 14. In a preferred embodiment, the wireless transceiver interface 108, 109 uses radio frequency (“rf”) radiation as is disclosed in the Bluetooth™ Specification v1.0 B. In a preferred embodiment the wireless transceiver interface operates at a frequency of 2.4 ghz, has an operating range of at least ten meters, and contains built in error correction.

Alternatively, other wireless interfaces using infrared and other rf interfaces that are know in the art can be used for communication between the electronic imaging camera 12 and the hard copy printer 14. The electronic imaging camera 12 and hard copy printer 14 can communicate to other wireless enabled devices such as scanners, palm devices, pagers, set top boxes, cell phones, GPS receivers, web television, and other digital and analog video devices. The base unit 80 and the personal computer 70 can alternatively contain a wireless transceiver interface (not shown) for transmitting and receiving image data and control information. The operator can select automatic uploading and subsequent transmission to the Internet of electronic image data when the electronic imaging camera 12 is within the wireless range of a wireless enabled base unit 80 or personal computer 70. When physically docked in the base unit 80, the electronic imaging camera 12 receives power to operate and recharge a battery through camera recharge connector 103 which is mechanically and electrically connected to the base unit 80 through recharge connector 101.

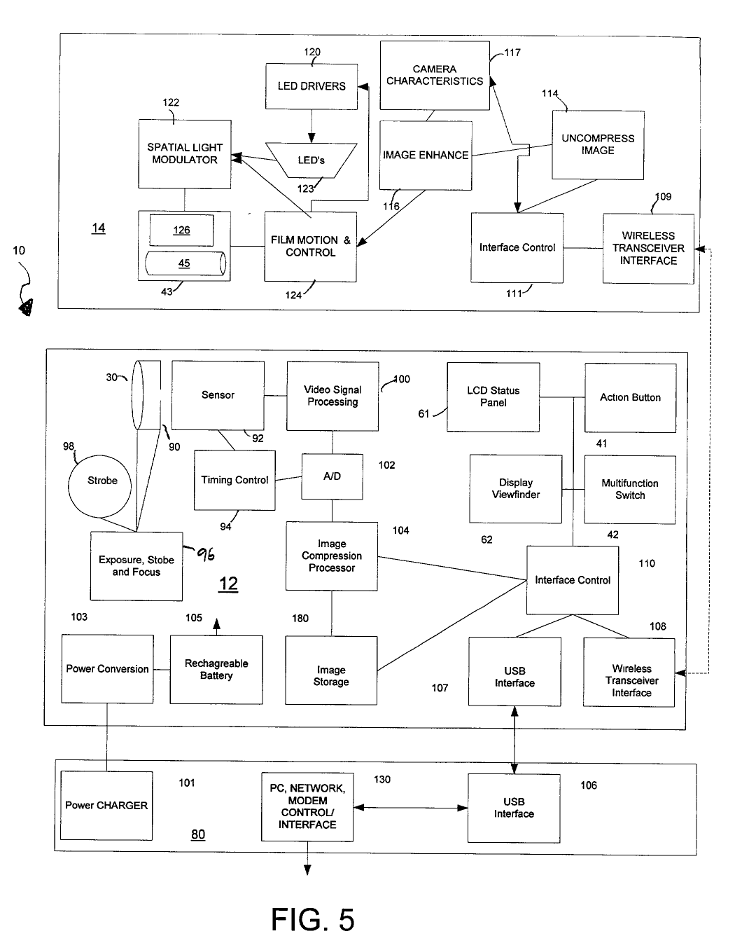

As shown in FIG. 5, the electronic imaging system 10 of this invention further includes image storage 180 in the electronic imaging camera housing 18 and electrically connected to an interface control 110. The image storage 180 preferably comprises a solid state memory. Alternatively a micro-disk memory such as a hard disk, flexible magnetic disk or writable optical disk could be used to supply greater storage capacity. Wireless transceiver interface 108 and wireless transceiver interface 109 are preferably an rf based industry standard such as Bluetooth™. The electronic imaging camera 12 can be docked with or without the hard copy printer 14 in the base unit 80 so that the power charger 101 in the base unit 80 is in electrical contact with a power conversion recharge circuit 103 in order to supply power to the electronic imaging camera 12 while docked and also recharge camera rechargeable battery 105. The rechargeable battery 105 and the power conversion recharge circuit 103 provide a power supply for the electronic imaging camera 12. The electronic imaging camera 12 and the hard copy printer 14 contain wireless transceiver interfaces 108, 109 which allow communication of data and control information between all wireless enabled components. The base unit 80 can serve as a data pass through to a personal computer 70, modem 82 and/or network 84 via USB interfaces 106, 107 and control interface 130. The USB interface currently offers a higher transfer rate than is practical in wireless devices.

Referring again to FIG. 5, there is shown a circuit block diagram for the electronic imaging system 10 of this invention. The electronic imaging camera 12 comprises the objective taking lens 30 for viewing the scene to be electronically recorded and directing the image defining scene light rays to a two-dimensional photoresponsive area array as shown at 92 preferably comprising a high resolution charge coupled device (CCD) or alternatively a charge injection device (CID), a CMOS device or any solid state light responsive array sensor. The photoresponsive array 92 comprises a plurality of image sensing elements or pixels arranged in a two dimensional area array wherein each image sensing pixel converts the incident image defining scene light rays into a corresponding analog voltage value. The transmission of scene light by way of the objective taking lens 30 to the photoresponsive array 92 is controlled by a shutter as shown at 90. The duration of each still image exposure interval is controlled in a conventional manner by way of an exposure, strobe, and focus control circuit 96. As is readily apparent, the circuit 96 may also operate to automatically control the focus of the objective taking lens 30 in any well-known manner such as by way of sonar or infrared rangefinders. In addition, the control circuit 96 also operates to effect the discharge of an electronic strobe flashtube 98 at the precise moment during the exposure interval.

After the exposure interval, the analog values of the individual pixels of the photoresponsive array 92 are transferred out in a conventional manner by timing clock pulses provided from a timing and control circuit 94. The electronic information signals output from the photoresponsive array 92 are serially transferred to a video signal processing circuit 100 in which the electronic information signals are amplified and filtered in a well-known manner. In addition, a black or dark current reference voltage may also be clamped to a select reference voltage level in a manner as is well known in the art. The electronic information output signals from the video signal processing circuit 100 are thereafter directed to an analog-to-digital converter 102 for conversion from an analog format to a digital format again in a manner as is well known in the art. The digitally formatted electronic information signals are thereafter directed to an image compression processor circuit 104 for compression again in any well-known manner.

To effect printing the processed, digitally formatted, and compressed electronic image information signals are directed to for transmission by way of the wireless transceiver interface 108 and wireless transceiver interface 109 to the hard copy printer 14. The processed, digitally formatted, and compressed electronic image information signals can be stored in the image storage 180 and later can be selected via the user interface and transmitted to the hard copy printer 14. At the electronic imaging camera user's discretion by way of appropriately actuated switches on the electronic imaging camera housing 16 there is provided an appropriate signal via wireless transceiver interfaces 108, 109 to interface control circuit 111 to direct the electronic image information signals received from the electronic imaging camera 12 to a circuit 114 for uncompressing the previously compressed electronic image information signals.

The uncompressed electronic image information signals are thereafter directed to an image enhancement circuit 116 whereby the electronic image information signals may be enhanced in a well-known manner as more fully described in U.S. Pat. No. 4,783,840, entitled “Method for Enhancing Image Data By Noise Reduction or Sharpening,” by Woo-Jin Song, issued Nov. 8, 1988, U.S. Pat. No. 4,779,142, entitled “System and Method For Electronically Recording and Playing Back Video Images With Improved Chrominance Characteristics Using Alternate Even and Odd Chrominance Signal Line Matrix Encoding,” by William T. Freeman et al., issued Oct. 18, 1988, or U.S. Pat. No. 4,774,565, entitled “Method and Apparatus For Reconstructing Missing Color Samples,” by William T. Freeman, issued Sep. 27, 1988, all in common assignment herewith and now all incorporated by reference herein.

The electronic imaging camera 12 characteristics can be down loaded from the electronic imaging camera 12 into the hard copy printer's 14 camera characteristic processing module 117 thereafter directed to the image enhancement circuit 116 whereby the electronic image information signals may be further enhanced in a well-known manner as more fully described in U.S. Pat. No. 5,694,484, entitled “Image Quality Architecture (IQA) Platform & Logic,” by Cottrell et al., issued Dec. 2, 1997, U.S. Pat. No. 5,809,164, entitled “Ideal Colorimetric Reproduction of an Image,” by Hultgren., issued Sept. 15, 1998, U.S. Pat. No. 5,724,456, entitled “Automatically Providing Maximum Luminance Data of an Image to a Destination Device,” by Boyack et al., issued Mar. 3, 1998, U.S. application Ser. No. 08/709,487, entitled “Spatial Profiles,” by Hultgren et al., filed Sep. 9, 1996 and now allowed, U.S. Pat. No. 5,235,434, entitled “Selectively Adjusting the Brightness of a Region of an Image,” by Wober, issued Oct. 8, 1996, and U.S. application Ser. No. 08/996,810, entitled “Spatial Profile Generation,” by Reuman, filed Dec. 23, 1997, all in common assignment herewith and now all incorporated by reference herein. Other image quality enhancement methods, as are known in the art, can also be incorporated in the printing process. Hard copy printer 14 can download software components from a computer or internet through the wireless transceiver interface 109 including but not limited to image quality enhancement routines, device specific characteristic tables, templates, and special effects software and images.

Electronic image information signals may also be simultaneously directed from the image enhancement circuit 116 to a light emitting diode (LED) driving circuit 120 which, in turn, provides the appropriate drive signals to a plurality of light emitting diodes (LED's) 123 and a spatial light modulator 122 which, in turn, expose a photographic film unit 126 of the self-processing type in film pack 43. The film unit 126 is advanced past the spatial light modulator 122 by appropriate drive rollers rotatably driven by a motor (not shown) under the control of a film motion and control circuit 124. The spatial light modulator 122 controls the amount of radiation from the LED's 122 which exposes the film unit 126. The LED's drivers 120 and the spatial light modulator 122 are controlled in a manner as is fully described in the electronic printer patents and co-pending applications which have been cross referenced and incorporated by reference. The film processing rollers ultimately advance the film unit 126 out of the film printer housing 44 by way of the exit slot 60 in a manner as described in the patents and co-pending applications which have been cross referenced and incorporated by reference. Thus, in this manner there can be provided an immediate hard copy of the scene sensed during the above-described exposure interval.

The hard copy printer 14 can determine the identification of the electronic imaging camera 12 transmitting data over the wireless transceiver interfaces 108, 109. Multiple electronic imaging cameras 12 can transmit electronic images to the hard copy printer 14 for printing. The hard copy printer 14 can be configured to either print an image or reject the data from a specific electronic imaging camera 12 depending on user configuration. The hard copy printer 14 can also determine from the electronic imaging camera 12 identification data which indicates format, resolution and electronic imaging camera 12 specific image enhancement parameters to be used in the printing process.

The electronic images stored in the image storage 180 device of the electronic imaging camera 12 may be directed by way of an interface control 110 to the liquid crystal display in the display viewfinder 62 on the electronic imaging camera 12 or the currently sensed still image can be displayed.

Referring again to FIG. 3, the hard copy printer 14 is powered in a preferred embodiment by an integral battery 45 in the film pack of self-processing type film 43. In an alternate embodiment the hard copy printer 14 can be powered from a separate power source and use a film pack without a battery. In the preferred embodiment the size of the self-processing type film is a medium format such as Polaroid Captiva™ as is known in the art, but in other embodiments the film size can be larger or smaller and is limited only by the size of the hard copy print engine 14. In an alternate embodiment the hard copy printer 14 could use other media besides self-processing type film such as but not limited to thermal, wax, wax thermal, or silver halide base media. The print engine could be a LED scanning printer as described above and in the previously cross referenced applications or alternatively could be a linear type printer such as a field emission printer or an area device type printer wherein all pixels of the image area are exposed simultaneously and the media can be stationary or moving.

Referring again to FIG. 5, the electronic imaging camera user by actuating the appropriate switches in the electronic imaging camera control action button 41 and multifunction switch 42 while still in the field can provide the appropriate control signals by way of interface control circuit 111 in the hard copy print engine 14 and interface control circuit 110 in the electronic imaging camera 12, respectively, to effect any one of a combination of the aforementioned functions. For instance, the electronic imaging camera user can direct the electronic information signals for each scene for storage in the storage device 180. The electronic image information signals can then be recalled for display on the display viewfinder 62 to determine what images are to be transformed into hard copy prints. The electronic imaging camera user can have the further option of storing none of the electronic image information signals in the image storage 180 but instead directing the signals to provide immediate hard copies in the manner as now provided by conventional instant photographic cameras of the type manufactured and sold by Polaroid Corporation. Alternatively, the user may decide not to print any hard copies in the field at all but instead direct all the images for storage in the image storage 180. She can then, with or without the hard copy printer 14, take the camera to any convenient place where there is located a wireless enabled device, and she can proceed to retrieve the previously recorded images from the image storage 180 for viewing on the computer 70 and printing of selected images at her discretion.

Alternatively, the electronic imaging camera 12 may be taken into the field without the hard copy printer 14 for more convenient carrying and handling. The electronic imaging camera 12 can then be utilized to record a plurality of scenes which are ultimately stored in the image storage 180. Thus, in this manner there is provided an electronic imaging system having tremendous versatility and capability by providing immediate hard copies in the field or alternatively permitting the recording of images electronically in the field with a small compact electronic imaging camera 12 and the subsequent automatic downloading of the images to a local computer or a computer connected via a network for selective viewing and printing of such recorded images in the comfort of the user's home or any location connected via a network such as the Internet.

In the case where the electronic imaging camera user operates the system to print a hard copy, he may then have the option by way of actuating the multifunction switch 42 and viewing a menu on a display viewfinder 62 to select which stored electronic image should be sent by way of the wireless transceiver interface 108 to the hard copy printer 14 or if docked in the base unit 80 by way of the USB interface 107 through the base unit 80 to the personal computer 70. The electronic imaging camera 12 can transmit one or all of the stored images through either the wireless transceiver interface 108 or the alternate data interface 107 which is a USB interface in a preferred embodiment.

The hard copy printer 14 can also function as a computer peripheral if the computer is equipped with a wireless transceiver interface (not shown) or if the electronic imaging camera 12 and hard copy printer 14 are docked in the base unit 80 which is connected to the personal computer 70.

Referring now to FIG. 6, the electronic imaging camera 12 includes and upper portion 18 and a lower portion 19. The lower portion 19 has an action button 41 which can be used as shutter button which is controlled by the operators index finger and can operate to produce the equivalent of a double mouse click. The lower portion 19 also has a thumb-operable clickable roller multifunction switch 42 (also known as a scroll jog wheel) which can be used to make menu selections and operate to produce the equivalent of a single mouse click. Use of the display viewfinder in cooperation with the thumb-operable clickable roller multifunction switch 42 and action button 41 allows the operator to perform all control tasks simply with one hand by interacting with displayed information on the display viewfinder 62 screen.

The upper portion 18 of the electronic imaging camera 12 includes the display viewfinder 62 and an optional LCD status panel 61. The information displayed on an optional LCD status panel 61 includes battery life remaining, snapshots remaining, which is an indication of the number of additional new images which can be stored in the image storage 180. Information collected from the hard copy printer 14 by means of the wireless transceiver interface 109 such as the number of prints remaining can also be displayed on the LCD status panel 61. In order to lower the system cost, the displayed information on the LCD status panel 61 could be electronic imaging camera 12 and hard copy printer 14 are docked in the base unit 80 which is connected to the personal computer 70.

Referring now to FIG. 6, the electronic imaging camera 12 includes and upper portion 18 and a lower portion 19. The lower portion 19 has an action button 41 which can be used as shutter button which is controlled by the operators index finger and can operate to produce the equivalent of a double mouse click. The lower portion 19 also has a thumb-operable clickable roller multifunction switch 42 (also known as a scroll jog wheel) which can be used to make menu selections and operate to produce the equivalent of a single mouse click. Use of the display viewfinder in cooperation with the thumb-operable clickable roller multifunction switch 42 and action button 41 allows the operator to perform all control tasks simply with one hand by interacting with displayed information on the display viewfinder 62 screen.

The upper portion 18 of the electronic imaging camera 12 includes the display viewfinder 62 and an optional LCD status panel 61. The information displayed on an optional LCD status panel 61 includes battery life remaining, snapshots remaining, which is an indication of the number of additional new images which can be stored in the image storage 180. Information collected from the hard copy printer 14 by means of the wireless transceiver interface 109 such as the number of prints remaining can also be displayed on the LCD status panel 61. In order to lower the system cost, the displayed information on the LCD status panel 61 could be presented on the display viewfinder 62 and the LCD status panel 61 could be eliminated.

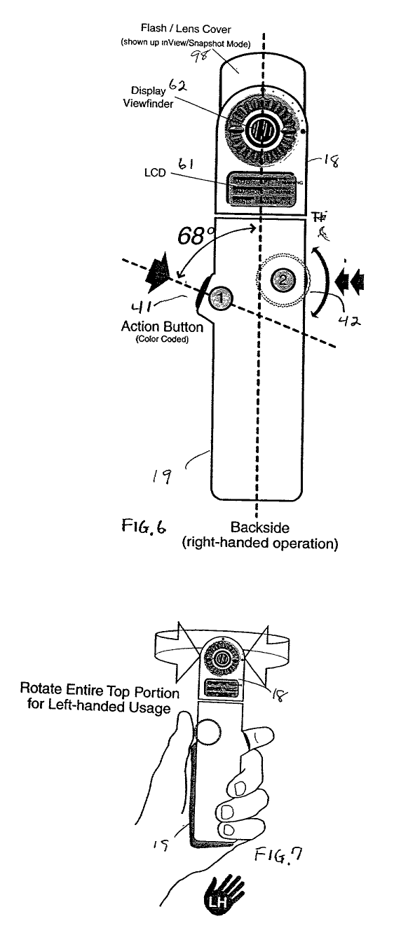

In order to accommodate a left handed user the upper portion 18 of the electronic imaging camera 12 can be rotated 180 degrees with respect to the lower portion of the electronic imaging camera 19 as shown in FIG. 7.

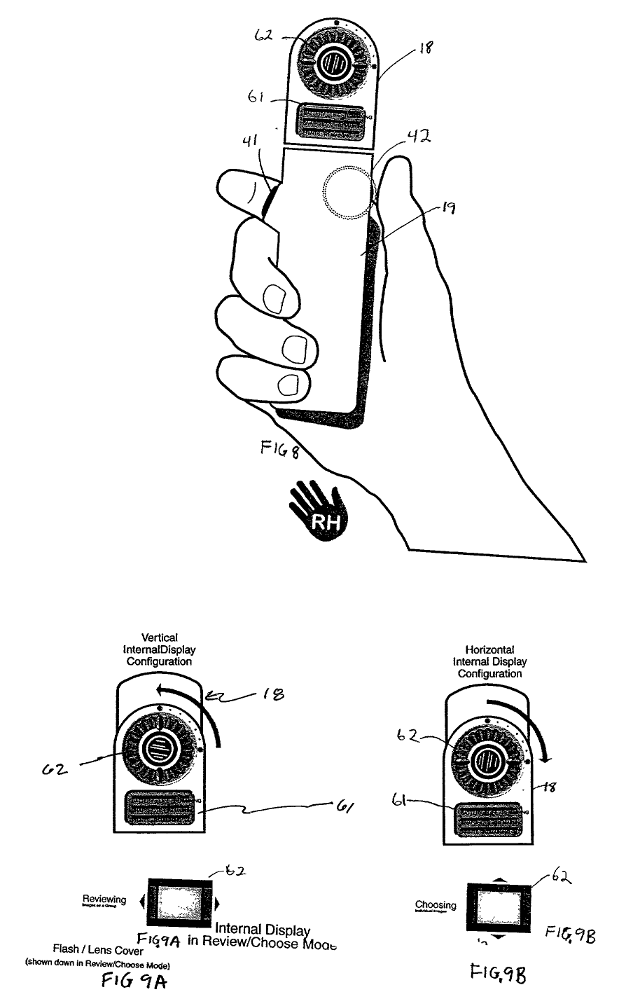

The operation of an action button 41 and the thumb-operable clickable roller switch 42 is shown in FIG. 8. As shown in FIGS. 9A and 9B, the display viewfinder 62 is rotateable between a horizontal and a vertical position. In the horizontal position the operator might scroll through images stored in the electronic imaging camera 12 image storage 180. In the vertical position the operator can scroll up and down menus for operating the electronic imaging camera 12 and the hard copy printer 14. See appendix pages a1, a2, a3, a5 for further details on the ergonomic features according to this invention.

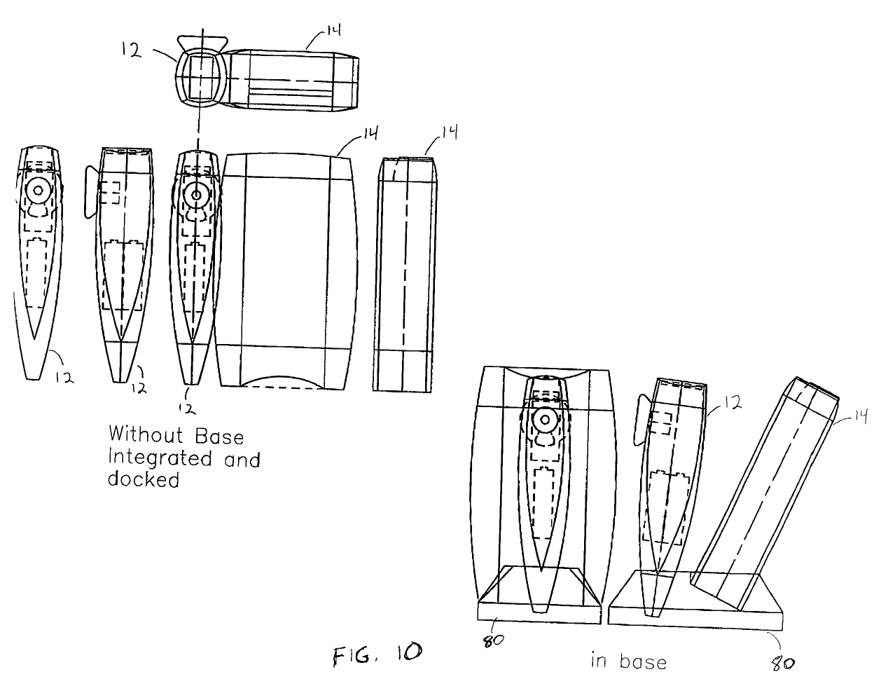

FIG. 10 shows some of the possible integrated and docking combinations among the electronic imaging camera 12, hard copy printer 14 and base unit 80.

In another embodiment, the electronic imaging camera 12 has audio input. In addition to image data, a limited amount sound data can be recorded on film. A recording of approximately 20-30 seconds can be stored on the last 3 or 5 lines of the saved electronic image data.

Other embodiments of the invention, including additions, subtractions, deletions and other modifications of the preferred disclosed embodiments of the invention will be obvious to those skilled in the art and are within the scope of the following claims.

What is claimed is:

1. A modular electronic imaging system comprising: a electronic imaging camera housing of a size that is conveniently carried by hand;
an objective lens operatively disposed with respect to said electronic imaging camera housing to receive and focus incident image defining scene light;
a solid state light responsive array disposed within said electronic imaging camera housing for receiving incident scene light by way of said objective lens and converting such scene light into an image defining electronic information signal;
a wireless transceiver interface disposed within said electronic imaging camera housing;
a power supply disposed within said electronic imaging camera housing;
a printer housing distinct from said electronic imaging camera housing and also of a size that is conveniently carried by hand and which can be mechanically attached to said electronic imaging camera housing;
a print engine which produces hard copy prints, disposed within said printer housing; and
a wireless transceiver interface, disposed within said printer housing, to communicate with said electronic imaging camera wireless transceiver interface.

2. The system of claim 1 further comprising:
a base unit comprising a housing, a connector which mates with said electronic imaging camera, a connection for supplying power to said electronic imaging cameras.

3. The system of claim 2 wherein said base unit further comprises a network access interface circuit

4. The system of claim 2 wherein said base unit further comprises a modem.

5. The system of claim 2 wherein said base unit further comprises a connection to a personal computer.

6. The system of claim 1 wherein the print engine which produces hard copy prints on self-processing type film.

7. The system of claim 1 wherein the print engine which produces hard copy prints on D2/T2 media.

8. The system of claim 1 further comprising:
a display viewfinder disposed in said camera housing;
an interface control circuit in electrical communication with said display viewfinder;
an action button in electrical communication with said interface control circuit;
a rotateble and clickable multifunction switch in electrical communication with said interface control circuit.

9. The system of claim 1 further comprising:
a rotateable upper portion of said camera wherein the camera can be configured for left handed or right handed operation.

10. The system of claim 1 wherein said printer further comprises:
means for downloading camera device characteristics; and
means for applying image quality enhancements based on said camera device characteristics.

11. The system of claim 1 wherein said camera further comprises:
a unique electronic imaging camera identification code.

12. The system of claim 1 further comprising:
means for automatically downloading images from said camera into a local computer.

13. The system of claim 1 further comprising:
means for automatically downloading images from said camera into a networked computer.
